(19) United States
(12) Patent Application Publication
(10) Pub. No.: US 2019/0045369 A1
(43) Pub. Date: Feb. 7, 2019

(54) USER TERMINAL, RADIO BASE STATION AND RADIO COMMUNICATION METHOD

(71) Applicant: NTT DOCOMO, INC., Tokyo (JP)

(72) Inventors: Hiroki Harada, Tokyo (JP); Satoshi Nagata, Tokyo (JP); Lihui Wang, Beijing (CN); Liu Liu, Beijing (CN); Huiling Jiang, Beijing (CN)

(73) Assignee: NTT DOCOMO, INC., Tokyo (JP)

(21) Appl. No.: 16/074,711

(22) PCT Filed: Feb. 2, 2017
(86) PCT No.: PCT/JP2017/003703

§ 371 Date: Aug. 1, 2018

(30) Foreign Application Priority Data
Feb. 4, 2016 (JP) 2016-020218

(51) Int. Cl. H04W 16/14; H04W 24/10; H04W 72/12

(52) U.S. Cl. CPC H04W 16/14; H04W 72/1263; H04W 24/10

(57) ABSTRACT

A user terminal communicates using a cell in which listening is applied at least prior to DL transmission, and has a measurement section that measures a channel state using a channel state measurement reference signal, and a control section that controls transmission of channel state information at a predetermined timing, and the control section controls whether to transmit the channel state information based on a measurement state of the channel state, and also controls transmission of indication information that indicates a cell where the channel state information is transmitted.

### TECHNICAL FIELD

The present invention relates to a user terminal, a radio base station and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). The specifications of LTE-advanced (Rel. 10 to 12) have been drafted for the purpose of achieving further broadbandization and higher speeds beyond LTE, and, in addition, for example, a successor system of LTE—referred to as “5G” (5th generation mobile communication system)—is under study.

The specifications of Rel. 8 to 12 LTE have been drafted assuming exclusive operations in frequency bands that are licensed to operators—that is, licensed bands. As licensed bands, for example, 800 MHz, 1.7 GHz and 2 GHz are used.

In recent years, user traffic has been increasing steeply following the spread of high-performance user terminals (UE: User Equipment) such as smart-phones and tablets. Although more frequency bands need to be added to meet this increasing user traffic, licensed bands have limited spectra (licensed spectra).

Consequently, a study is in progress with Rel. 13 LTE to enhance the frequencies of LTE systems by using bands of unlicensed spectra (also referred to as “unlicensed bands”) that are available for use apart from licensed bands (see non-patent literature 2). For unlicensed bands, for example, the 2.4 GHz band and the 5 GHz band, where Wi-Fi (registered trademark) and Bluetooth (registered trademark) can be used, are under study for use.

To be more specific, with Rel. 13 LTE, a study is in progress to execute carrier aggregation (CA) between licensed bands and unlicensed bands. Communication that is carried out by using unlicensed bands with licensed bands like this is referred to as “LAA” (License-Assisted Access). Note that, in the future, dual connectivity (DC) between licensed bands and unlicensed bands and stand-alone (SA) in unlicensed bands may become the subject of study under LAA.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall Description; Stage 2”

Non-Patent Literature 2: AT&T, Drivers, Benefits and Challenges for LTE in Unlicensed Spectrum, 3GPP TSG-RAN Meeting #62 RP-131701

### SUMMARY OF INVENTION

### Technical Problem

For unlicensed bands, a study is in progress to introduce interference control functionality in order to allow co-presence with other operators' LTE, Wi-Fi or other different systems. In Wi-Fi, LBT (Listen Before Talk), which is based on CCA (Clear Channel Assessment), is used as an interference control function for use within the same frequency.

Consequently, when unlicensed bands are configured in LTE systems, UL transmission and/or DL transmission may be controlled by implementing “listening” (for example, LBT) as an interference control function.

Meanwhile, if transmission is controlled by applying listening, the presence or absence of transmission and the transmission timing are changed based on the result of listening performed before transmission. For example, it is assumed that a UL signal (for example, channel state information) is transmitted at a predetermined timing based on a DL signal (for example, reference signal) received by the user terminal in an unlicensed band.

In this case, depending on the result of DL listening, the DL signal may not be transmitted, and there is a risk that the UL signal cannot be appropriately fed back at a predetermined timing. In this way, if communication method used in existing radio communication systems (for example, LTE Rel. 8 to 12) is directly applied to cells where application of listening is stipulated, there is a possibility that communication cannot be performed properly.

The present invention has been made in view of the forgoing, and it is therefore an object of the present invention to provide a user terminal, a radio base station and a radio communication system, whereby adequate communication can be carried out in a communication system using cells where application of listening is stipulated).

### Solution to Problem

According to one aspect of the present invention, a user terminal communicates using a cell in which listening is applied at least prior to DL transmission, and has a measurement section that measures a channel state using a channel state measurement reference signal, and a control section that controls transmission of channel state information at a predetermined timing, and, in this user terminal, the control section controls whether to transmit the channel state information based on a measurement state of the channel state, and also controls transmission of indication information that indicates a cell where the channel state information is transmitted.

### Advantageous Effects of Invention

According to the present invention, adequate communication can be carried out in a communication system using cells where application of listening is stipulated.

### BRIEF DESCRIPTION OF DRAWINGS

FIG. 1A to FIG. 1C are diagrams to show examples of CSI transmission methods in existing systems;

FIG. 2A and FIG. 2B are diagrams to explain CSI transmission methods in unlicensed CCs;

FIG. 3A and FIG. 3B are diagrams to explain CSI transmission methods in unlicensed CCs;

FIG. 4A to FIG. 4C are diagrams to show examples of CSI transmission methods according to the present embodiment;

FIG. 5A to FIG. 5B are diagrams to show examples of CSI transmission methods according to the present embodiment;

FIG. 6 is a diagram to show an example of a CSI transmission method according to the present embodiment;

FIG. 7A and FIG. 7B are diagrams to show other examples of CSI transmission methods according to the present embodiment;

FIG. 8 is a diagram to show another example of a CSI transmission method according to the present embodiment;

FIG. 9A and FIG. 9B are diagrams to show other examples of CSI transmission methods according to the present embodiment;

FIG. 10 is a diagram to show an example of a schematic structure of a radio communication system according to the present embodiment;

FIG. 11 is a diagram to show an example of an overall structure of a radio base station according to the present embodiment;

FIG. 12 is a diagram to show an example of a functional structure of a radio base station according to the present embodiment;

FIG. 13 is a diagram to show an example of an overall structure of a user terminal according to the present embodiment; and

FIG. 14 is a diagram to show an example of a functional structure of a user terminal according to the present embodiment; and

FIG. 15 is a diagram to show an example hardware structure of a radio base station and a user terminal according to one embodiment of the present invention.

### DESCRIPTION OF EMBODIMENTS

As mentioned earlier, in systems that run LTE/LTE-A in unlicensed bands (for example, LAA systems), interference control functionality is likely to be necessary in order to allow co-presence with other operators' LTE, Wi-Fi, or other different systems. Note that systems that run LTE/LTE-A in unlicensed bands may be collectively referred to as “LAA,” “LAA-LTE,” “LTE-U,” “U-LTE” and so on, regardless of whether the mode of operation is CA, DC or SA.

Generally speaking, when a transmission point (for example, a radio base station (eNB), a user terminal (UE) and so on) that communicates by using a carrier (which may also be referred to as a “carrier frequency,” or simply a “frequency”) of an unlicensed band detects another entity (for example, another user terminal) that is communicating in this unlicensed band carrier, the transmission point is disallowed to make transmission in this carrier.

Therefore, the transmission point performs listening (LBT: Listen Before Talk) at a timing a predetermined period ahead of a transmission timing. To be more specific, by executing LBT, the transmission point searches the whole of the target carrier band (for example, one component carrier (CC)) at a timing that is a predetermined period ahead of a transmission timing, and checks whether or not other devices (for example, radio base stations, user terminals, Wi-Fi devices and so on) are communicating in this carrier band.

Note that, in the present description, “listening” refers to the operation which a given transmission point (for example, a radio base station, a user terminal, etc.) performs before transmitting signals in order to check whether or not signals to exceed a predetermined level (for example, predetermined power) are being transmitted from other transmission points. Further, the listening performed by radio base stations and/or user terminals may be referred to as “LBT,” “CCA” (Clear Channel Assessment), “carrier sensing,” or the like.

The transmission point then carries out transmission using this carrier only if it is confirmed that no other devices are communicating. If the received power measured during LBT (the received signal power during the LBT period) is equal to or lower than a predetermined threshold, the transmission point judges that the channel is in the idle state (LBT idle), and carries out transmission. When a “channel is in the idle state,” this means that, in other words, the channel is not occupied by a specific system, and it is equally possible to say that a channel is “idle,” a channel is “clear,” a channel is “free,” and so on.

On the other hand, if only just a portion of the target carrier band is detected to be used by another device, the transmission point stops its transmission. For example, if the transmission point detects that the received power of a signal from another device entering this band exceeds a threshold, the transmission point judges the channel is in the busy state (LBT_{busy}), and makes no transmission. In the event LBT_{busy} is yielded, LBT is carried out again with respect to this channel, and the channel becomes available for use only after it is confirmed that the channel is in the idle state. Note that the method of judging whether a channel is in the idle state/busy state based on LBT is by no means limited to this.

As LBT mechanisms (schemes), FBE (Frame Based Equipment) and LBE (Load Based Equipment) are currently under study. Differences between these include the frame configurations to use for transmission/receipt, the channel-occupying time, and so on. In FBE, the LBT-related transmitting/receiving configurations have fixed timings. Also, in LBE, the LBT-related transmitting/receiving configurations are not fixed in the time direction, and LBT is carried out on an as-needed basis.

To be more specific, FBE has a fixed frame cycle, and is a mechanism of carrying out transmission if the result of executing carrier sensing for a certain period (which may be referred to as “LBT duration” and so on) in a predetermined frame shows that a channel is available for use, and not making transmission but waiting until the next carrier sensing timing if no channel is available.

On the other hand, LBE refers to a mechanism for implementing the ECCA (Extended CCA) procedure of extending the duration of carrier sensing when the result of carrier sensing (initial CCA) shows that no channel is available for use, and continuing executing carrier sensing until a channel is available. In LBE, random backoff is required to adequately avoid contention.

Note that the duration of carrier sensing (also referred to as the “carrier sensing period”) refers to the time (for example, the duration of one symbol) it takes to gain one LBT result by performing listening and/or other processes and deciding whether or not a channel can be used.

A transmission point can transmit a predetermined signal (for example, a channel reservation signal) based on the result of LBT. Here, the result of LBT refers to information about the state of channel availability (for example, “LBT_{idle},” “LBT_{busy},” etc.), which is acquired by LBT in carriers where LBT is configured.

Also, when a transmission point starts transmission when the LBT result shows the idle state (LBT_{idle}), the transmission point can skip LBT and carry out transmission for a predetermined period (for example, for 10 to 13 ms). This transmission is also referred to as “burst transmission,” “burst,” “transmission burst,” and so on.

As described above, by introducing interference control that is based on LBT mechanism and that is for use within the same frequency to transmission points in LAA systems, it becomes possible to prevent interference between LAA and Wi-Fi, interference between LAA systems and so on. Furthermore, even when transmission points are controlled independently per operator that runs an LAA system, LBT makes it possible to reduce interference without learning the details of each operator's control.

By the way, in existing LTE systems (Rel. 10 to 12), reference signals for measuring channel states in the downlink are defined. The reference signals for channel state measurements are also referred to as the “CRS” (Cell-specific Reference Signal) or the “CSI-RS” (Channel State Information-Reference Signal), and are reference signals used to measure CSI, including CQI (Channel Quality Indicator), PMI (Precoding Matrix Indicator) and RI (Rank Indicator) as a channel state.

The user terminal feeds back the measurement result based on the channel state measurement reference signal to the radio base station as channel state information (CSI) at a predetermined timing. Also, when the channel state is calculated based on the CSI-RS, it is important to take into account the influence of interference from other transmission points (other cells)). Therefore, interference from other transmission points can be estimated by using the CSI-RS resource for measuring desired signal power and the CSI-IM resource for measuring interference signal power. In this case, the user terminal transmits the channel state estimated based on the CSI-RS resource and the CSI-IM resource to the radio base station. Note that the combination of CSI estimated using a CSI-RS resource and a CSI-IM resource is called referred to as “CSI process.” Note that the user terminal can also measure desired signal power and interference signal power using cell-specific reference signals (CRS).

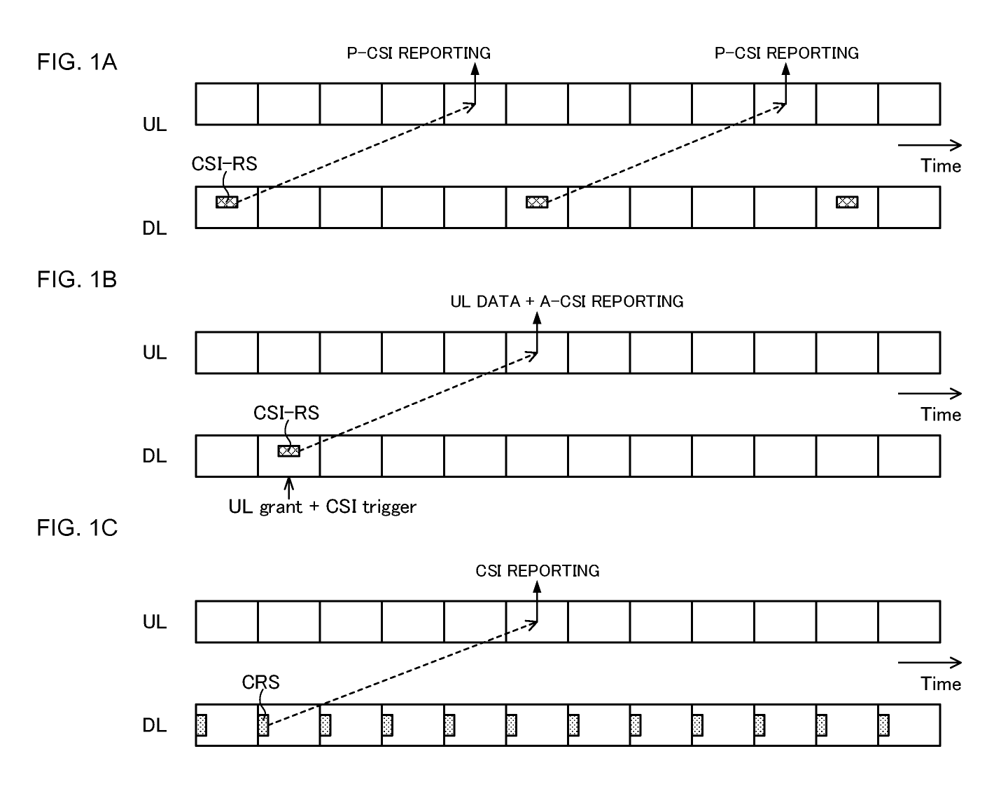

Periodic CSI reporting (P-CSI) and aperiodic CSI reporting (A-CSI) are defined as methods of feeding back CSI (see FIGS. 1A and 1B). FIG. 1A shows an example of transmission timing in periodic CSI (P-CSI) reporting, and FIG. 1B shows an example of transmission timing in aperiodic CSI (A-CSI) reporting.

When performing periodic CSI reporting, the user terminal feeds back P-CSI in a every predetermined periodicity (for example in a five-subframe periodicity, a ten-subframe periodicity, etc.) (see FIG. 1A). FIG. 1A shows a case where P-CSI is reported in a five-subframe periodicity.

When there is no uplink data (for example, PUCCH) transmission at a predetermined timing (predetermined subframe) at which P-CSI is reported, the user terminal transmits the P-CSI using an uplink control channel (for example, PUSCH). Also, when CA is employed, the user terminal transmits P-CSI using an uplink control channel of a predetermined cell (for example, PCell, PUCCH cell, PSCell). Meanwhile, when there is uplink data transmission at a predetermined timing, the user terminal can transmit P-CSI using an uplink shared channel.

When making aperiodic CSI reporting, the user terminal transmits A-CSI at a predetermined timing in response to a CSI trigger (CSI request) from the radio base station apparatus (see FIG. 1B)). FIG. 1B shows a case where, when a user terminal receives a CSI trigger, the user terminal reports A-CSI after a predetermined timing (for example, four subframes later). In addition, here, the transmission timings of the CSI trigger and the CSI-RS are the same, but the present invention is not limited to this.

The CSI trigger reported from the radio base station is included in downlink control information for an uplink scheduling grant (UL grant) transmitted in a downlink control channel (for example, DCI format 0/4). The user terminal transmits A-CSI using an uplink shared channel specified by the UL grant according to the trigger included in the downlink control information for the UL grant. Also, when CA is applied, the user terminal can receive a UL grant (including A-CSI trigger) for a certain cell in another cell's downlink control channel.

Also, the user terminal can measure channel states using the CRS transmitted in each subframe (see FIG. 1C). In this case, the user terminal reports the measured result (CSI) to the radio base station at a predetermined timing. In the following description, a case will be described in which channel state information is measured using the CSI-RS, but the present embodiment is not limited to this, and CRS-based channel state measurement is equally applicable.

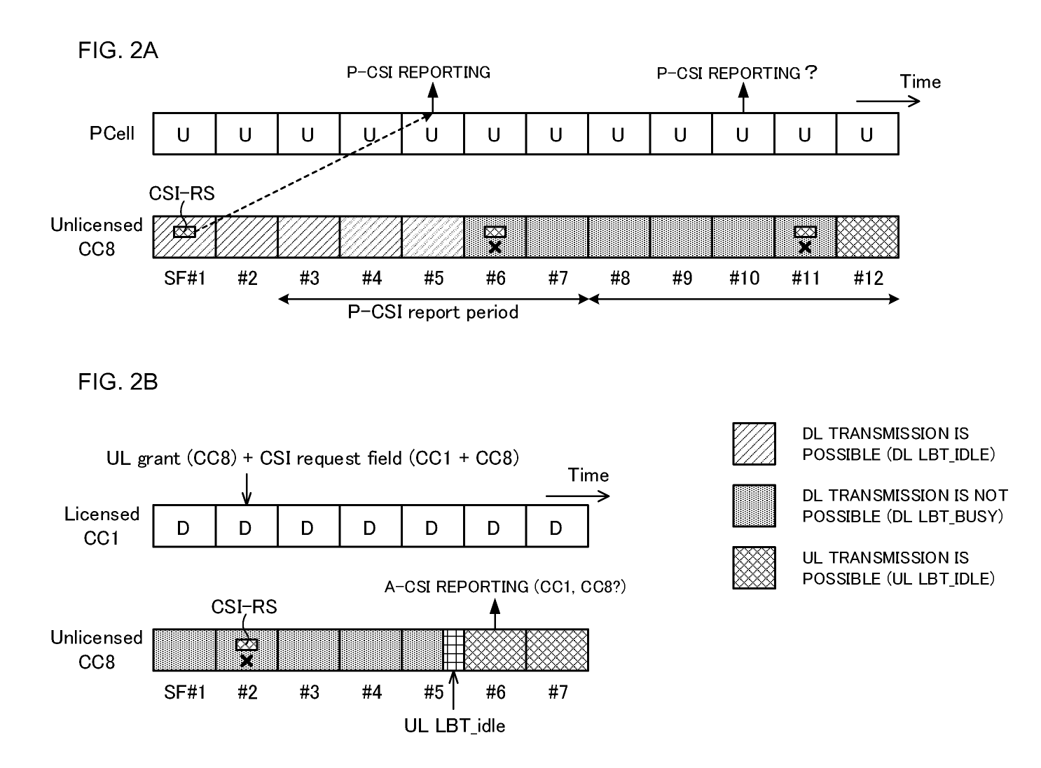

FIG. 2A shows an example of a periodic CSI (P-CSI) transmission method for use when the user terminal is connected with a cell in which listening is not employed (for example, a licensed CC) and a cell in which listening is employed (for example, an unlicensed CC). Further, in FIG. 2A, a case is assumed in which the user terminal is connected to a licensed CC (PCell) and an unlicensed CC (CC 8) and P-CSI is reported using the PCell's uplink control channel. In unlicensed CC 8, the CSI-RS transmission periodicity is configured to 5 ms, and the P-CSI reporting period is also configured to 5 ms (here, SF #1, #6 and #11).

In SF #1, indicating LBT_{idle} in unlicensed CC 8, the user terminal can receive the CSI-RS (CSI resource) transmitted in this unlicensed CC 8. Therefore, at a predetermined timing (SF #5), the user terminal transmits the CSI of unlicensed CC 8 using the PCell's uplink control channel.

However, in the case shown in FIG. 2A, DL transmission in SF #6 is restricted due to the result of DL listening in unlicensed CC 8 (LBT_{busy}), the CSI-RS is not transmitted in SF #6. In this case, in SF #6, the user terminal cannot receive or measure the CSI-RS via unlicensed CC 8. That is, in SF #10, the user terminal cannot transmit the measurement result of the CSI-RS that was scheduled to be transmitted via unlicensed CC 8 in SF #6.

Similarly, in SF #11, unlicensed CC 8 indicates LBT_{busy}, and therefore the user terminal cannot receive the channel state measurement resource in unlicensed CC 8.

FIG. 2B shows an example of an aperiodic CSI (A-CSI) transmission method for use when the user terminal is connected to a cell in which listening is not employed and a cell in which listening is employed. Further, in FIG. 2B, a case is assumed in which the user terminal is connected to a licensed CC (CC 1) and an unlicensed CC (CC 8) and A-CSI is reported using the uplink shared channel of unlicensed CC 8. In addition, here, it is shown that a UL grant (including CSI trigger) for unlicensed CC 8 is transmitted in licensed CC 1 by applying cross-carrier scheduling.

The radio base station transmits downlink control information including a UL transmission command and CSI request (CSI trigger) information for unlicensed CC 8 in SF #2 using the downlink control channel of licensed CC 1. Here, it is assumed that a CSI trigger of licensed CC 1 and a CSI trigger of unlicensed CC 8 are included as CSI triggers.

The user terminal performs UL transmission in an unlicensed CC after a predetermined timing (for example, SF #6, which comes four ms later) based on the downlink control information (UL grant and CSI trigger) received in licensed CC 1. At this time, the user terminal includes the CSI of licensed CC 1 and the CSI of unlicensed CC 8 in uplink data and transmits the uplink data.

However, in the case shown in FIG. 2B, DL transmission in SF #2 is restricted due to the result of DL listening in unlicensed CC 8 (LBT_{busy}), and so the CSI-RS is not transmitted in SF #2. In this case, the user terminal cannot receive or measure the CSI-RS of unlicensed CC 8 in SF #2. That is, in SF #6, the user terminal cannot transmit the measurement result of the CSI-RS that was scheduled to be transmitted via unlicensed CC 8 in SF #2.

In this way, in an unlicensed CC where DL transmission is controlled based on listening, The CSI-RS may not be transmitted depending on the result of listening. In such a case, how to report the CSI from the user terminal is the problem.

CSI reporting of existing systems is stipulated so that the user terminal reports the measurement result measured with the most recently (last) received valid reference signal resource (the latest valid RS resource) as CSI. Alternatively, CSI reporting is stipulated so that, in the absence of a valid reference signal resource, the user terminal does not report CSI. A valid reference signal resource means, for example, the latest DL subframe, including a channel state measurement reference signal, a predetermined period or more before a reporting subframe.

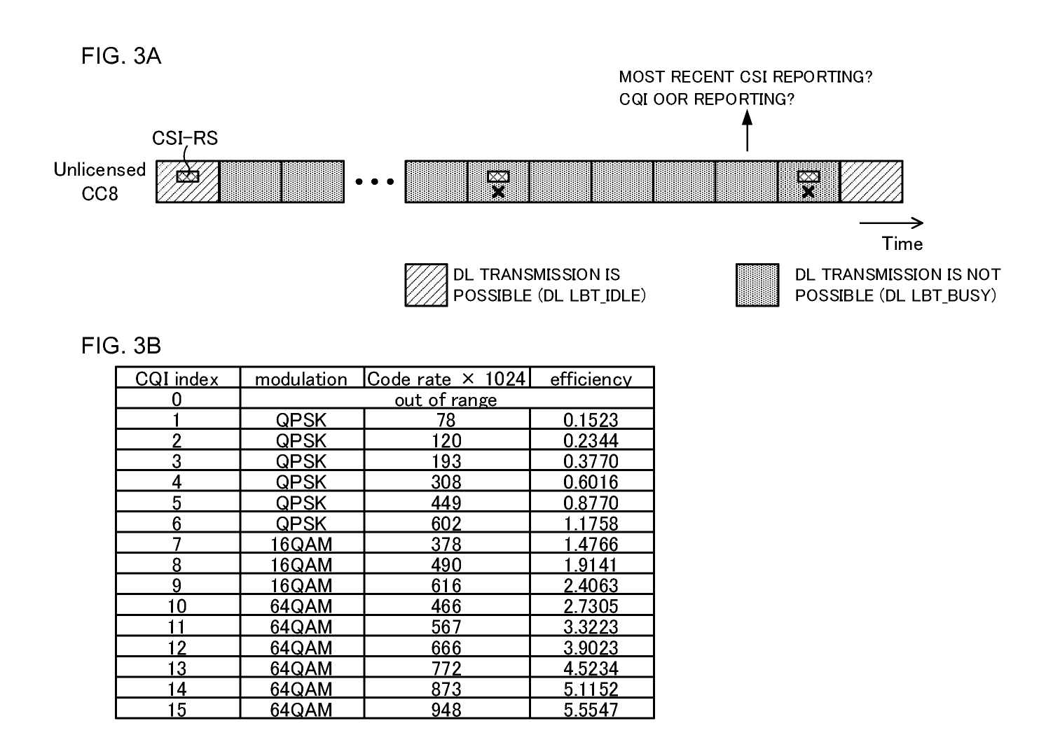

Even when using unlicensed CCs, it is possible to control CSI reporting in the same way as in existing systems. However, when, in an unlicensed CC, the LBT_{busy} period continues long, the period during which the CSI-RS is not transmitted also becomes long (see FIG. 3A). In this case, the result of the last reception and measurement of the CSI-RS (CSI) by the user terminal may be significantly different from the latest channel state. Therefore, in an unlicensed CC, when the user terminal reports the measurement result (CSI) of the CSI-RS received most recently (last) and the radio base station controls DL transmission based on the CSI, the quality of communication may deteriorate.

On the other hand, if valid CSI resources are limited (for example, if the receiving period of valid CSI-RSs is configured to be short), the LBT_{busy} period continues long, and the user terminal has to drop CSI reporting at each CSI report timing. When there is only one CSI to be reported in the reporting subframe (or CSI process), dropping CSI reporting means that nothing is transmitted, so there is no difference in recognition between the radio base station and the terminal. However, if there are multiple CSI processes to report in a reporting subframe, including unlicensed CCs, if CSI reporting is dropped in some CCs or CSI processes, the radio base station cannot determine which CSI process is dropped from the reported contents. In order to avoid such problems, even in the absence of valid CSI resources, it may be possible to send a report to the effect that the channel quality (CQI) is out of range (OOR: Out of range), instead of dropping reporting.

However, in existing systems, the CQI value and OOR are specified in the same table (CQI index=“0”), so that, even when reporting OOR, the same number of bits (for example four bits) are required as when reporting CQI values (see FIG. 3B). Therefore, if OOR continues being reported, the overhead of uplink transmission will increase and the efficiency of use of resources may decrease. In particular, if multiple unlicensed CCs are configured, the problem of increased overhead may become serious. Thus, in existing systems, the possibility that the channel state measurement reference signal may not be transmitted for a long period of time is not taken into consideration, so that it is difficult to apply the methods of existing systems to CSI reporting used in unlicensed CCs on an as-is basis.

Therefore, as one aspect of the present invention, the inventors of the present invention

have come up with the idea of allowing a user terminal to control whether or not to transmit channel state information, on a per cell basis (or on a per CSI process basis), based on the state of channel state measurement (or the receiving state of the channel state measurement reference signal), and, furthermore, transmit information (indication info) about the cells (or CSI processes) being the target of CSI reporting.

For example, a configuration may be employed, in which, when a user terminal transmits CSI at a predetermined timing, the user terminal selects and transmits only the CSI of cells where the CSI resource is received and measured, among the configured cells. In other words, when the user terminal transmits CSI at a predetermined timing, if measurement using a valid CSI resource cannot be performed in a certain cell (for example, an unlicensed CC), the user terminal is controlled not to transmit the CSI of that cell (and OOR). Further, the user terminal transmits indication information (indication info) designating the cells (or CSI processes)to be subjected to CSI reporting.

This allows unnecessary CSI reporting based on listening results (for example, LBT_{busy}) in unlicensed CCs to be reduced. By this means, it is possible to suppress an increase in overhead of UL. Further, the radio base station side can control DL transmission by appropriately knowing the channel state of each cell, so that it is possible to suppress degradation of communication quality.

In addition, as another aspect of the present invention, the inventors of the present invention have come up with the idea of transmitting other information, instead of channel state information, when the user terminal does not transmit the channel state information of a predetermined cell. For example, when the user terminal does not transmit a given cell's channel state information at a predetermined timing, the user terminal is controlled to transmit the channel quality measurement reference signal and/or the information related to received power for that cell. As a result of this, even if the user terminal does not send CSI reporting regarding a certain cell (for example, an unlicensed CC), other information/signals pertaining to that cell can be transmitted to the radio base station. As a result, appropriate scheduling can be performed on the radio base station side.

Now, embodiments of the present invention will be described in detail below with reference to the accompanying drawings. Although the present embodiment will be described assuming that a frequency carrier in which listening (LBT) is not configured is a licensed band and a frequency carrier in which listening is configured is an unlicensed band, this is by no means limiting. The embodiments herein are applicable to any frequency carriers (or cells, CCs, etc.), in which listening is configured, regardless of whether a frequency carrier is a licensed band or an unlicensed band.

Also, although cases will be shown in the following description where listening is employed in LTE/LTE-A systems, the embodiments herein are by no means limited to this. This embodiment can be applied to any system in which signal transmission is controlled by executing listening before channel state information is transmitted. The reference signal for measuring channel states may be a reference signal that can measure channel states, and, for example, the CRS or the CSI-RS can be used. Although cases will be described in the following description where the CSI-RS is used as the channel measurement reference signal, the present embodiment is equally applicable to cases where the CRS is used. Also, the present embodiment can be applied to both periodic CSI (P-CSI) and aperiodic CSI (A-CSI).

Also, the present embodiment can be applied when transmitting channel state information based on the measurement result of the channel state measurement reference signal. This embodiment can be applied even when the user terminal connects with one cell, or when the user terminal connects with a plurality of cells (when applying CA, DC, etc.). Further, although this embodiment can be suitably applied when the cells to which the user terminal is connected include cells in which listening is performed prior to DL transmission, the present embodiment is not limited to this.

Further, although, in the following description, the channel state information of each cell will be described as one CSI, when multiple CSI processes are configured for a user terminal in a single cell, this embodiment can be applied to each CSI process.

### FIRST EXAMPLE

In the first example, a case will be described in which whether or not to transmit the CSI of each cell is controlled based on the measurement state of channel states (CSI) of cells (the receiving state of the channel state measurement reference signal (CSI-RS and/or CRS)). In the following description, cases where control as to whether or not CSI is transmitted is applied to unlicensed CCs will be explained as examples, but the present embodiment is not limited to this. Cells where whether or not CSI is transmitted is controlled may be limited to unlicensed CCs, or may be licensed CCs and unlicensed CCs.

The user terminal selectively reports the CSI of cells where measurement can be performed using a valid CSI resource (where a valid CSI resource has been received). In addition, the user terminal transmits information on the CCs targeted for CSI reporting, as indication information, to the radio base station. The radio base station can identify the cells corresponding to the received CSI (cells where CSI was not transmitted from user terminal) based on the indication information transmitted from the user terminal.

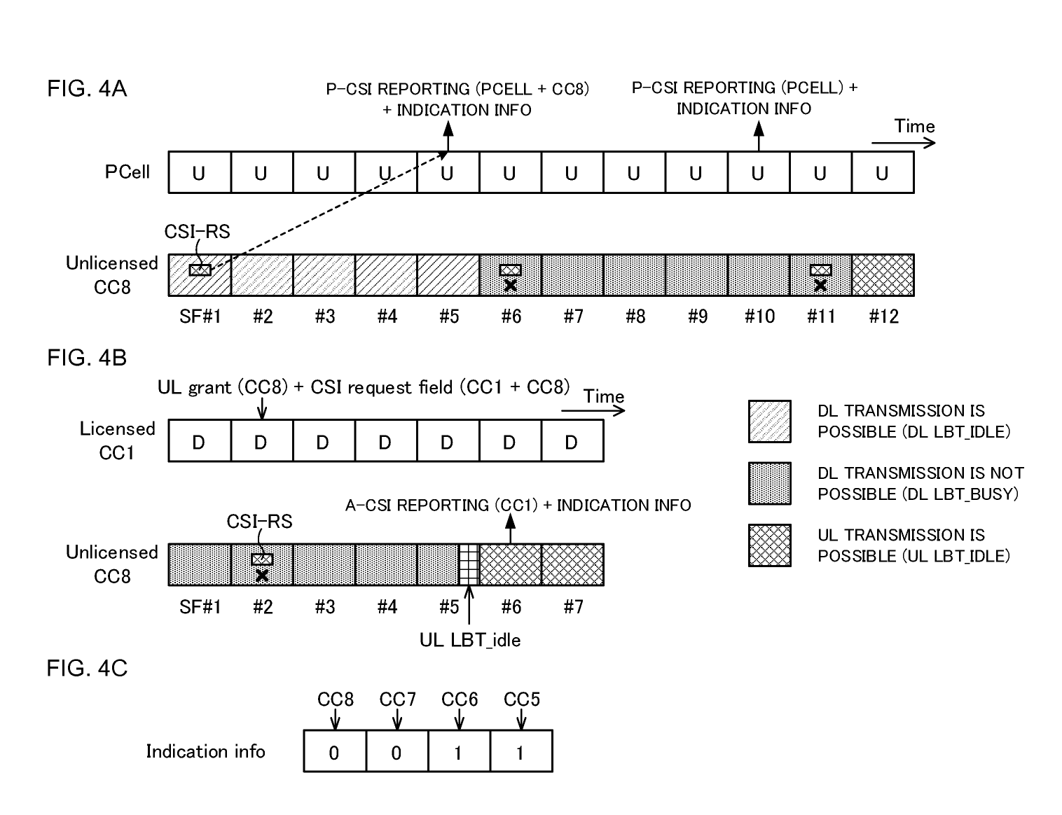

Hereinafter, an example of a method of controlling whether or not to transmit CSI will be described with reference to FIG. 4. FIG. 4A shows an example of a case where whether or not the user terminal transmits P-CSI is controlled, and FIG. 4B shows an example of a case where whether or not the user terminal transmits A-CSI is controlled. In FIGS. 4, only the latest CSI resource in a period before the timing of CSI reporting is used as a valid CSI resource, the present embodiment is not limited to this.

In FIG. 4A, a case is assumed in which the user terminal is connected to an licensed CC (PCell) and an unlicensed CC (CC 8), and reports P-CSI using the PCell's uplink control channel. In unlicensed CC 8, the CSI-RS transmission periodicity is configured to 5 ms, and the P-CSI reporting period (valid period) is also configured to 5 ms.

In the SF #1 indicating LBT_{idle}, the user terminal can receive the CSI-RS (CSI resource) transmitted in unlicensed CC 8. Therefore, at a predetermined timing (SF #5), the user terminal transmits the CSI of unlicensed CC 8 and the CSI of the PCell using the PCell's uplink control channel. Further, the user terminal also transmits information (indication information) including CSI reporting of unlicensed CC 8 to the radio base station.

On the other hand, in SF #6 indicating LBT_{busy}, the CSI-RS is not transmitted in unlicensed CC 8, so that the user terminal cannot receive or measure the CSI-RS. Therefore, at a given timing (SF #10), the user terminal reports the CSI of the PCell, but does not report the CSI of that unlicensed CC 8. In this case, the user terminal transmits indication information, not including CSI reporting corresponding to unlicensed CC 8, to the radio base station.

In FIG. 4B, a case is assumed in which the user terminal connects to licensed CC 1 and unlicensed CC (CC 8) and reports A-CSI using the unlicensed CC's uplink shared channel). In addition, here, the case where a UL grant (including a CSI trigger) for unlicensed CC 8 is transmitted in licensed CC 1 is shown.

In SF #2, the user terminal is controlled to receive downlink control information transmitted in licensed CC 1, and perform UL data transmission and CSI reporting in licensed CC 8 at a predetermined timing (here, SF #6). On the other hand, since SF #2 indicates LBT_{busy}, the CSI-RS is not transmitted in unlicensed CC 8, so that the user terminal cannot receive or measure the CSI-RS.

Therefore, at a predetermined timing (SF #6), the user terminal reports the CSI of licensed CC 1, but does not report the CSI of that unlicensed CC 8. In this case, the user terminal transmits indication information, not including CSI reporting corresponding to unlicensed CC 8, to the radio base station.

Also, the indication information may be configured to include an indication of whether or not CSI reporting corresponding to all cells to which the user terminal is connected is included, an indication of whether or not CSI reporting corresponding to a predetermined cell (for example, an unlicensed CC) is included among the cells to which the user terminal is connected.

For example, suppose that the user terminal is connected to X active unlicensed CCs). In this case, the user terminal can report the status of CSI reporting of the X unlicensed CCs to the radio base station in a bitmap format (for example, X bits). FIG. 4C shows an example of indication information transmitted to the radio base station when the user terminal is connected to four unlicensed CCs (CC #5 to CC #8).

The indication information shown in FIG. 4C can be configured so that “1” indicates that there is CSI reporting and “0” indicates that there is no CSI reporting. For example, assume that CSI reporting for CC #5 and CC #6 is valid at a predetermined timing and CSI reporting for CC #7 and CC #8 is not valid. In this case, in addition to the CSI reporting of CC #5 and CC #6, the user terminal transmits indication information (0011) indicating the presence or absence of CSI reporting corresponding to CC #8 to CC #5 to the radio base station. The radio base station can determine that there is no CSI reporting corresponding to CC #7 and CC #8 based on the CSI (CC #5 and CC #6) reported from the user terminal and the indication information.

Also, the present embodiment may be configured to apply the method of controlling whether or not CS is transmitted for each cell only when the uplink overhead is large. For example, when a predetermined value or more CSIs (CSI processes) are configured, the user terminal controls whether or not to transmit CSI. The predetermined value may be fixedly defined in advance, or may be configured in the user terminal by high layer signaling from the radio base station. Alternatively, the application of the method for controlling whether or not to transmit CSI for each cell itself may be configured in the user terminal by high layer signaling from the radio base station.

<Transmission Method of Indication Information>

When transmitting CSI (uplink control information including CSI) and indication information, the user terminal can appropriately control the mapping method according to the type of the UL channel for transmitting CSI. For example, when a user terminal communicates using a plurality of cells including an unlicensed CC, the user terminal can transmit uplink control information, including CSI (for example, P-CSI), in the uplink control channel of a predetermined cell (for example, a licensed CC that serves as the PCell) (case 1). The uplink control information (UCI) can include HARQ-ACKs, SRs, etc. in addition to CSI.

Also, when simultaneous transmission of uplink control channel and uplink shared channel is not configured, when there is transmission of uplink data at the timing at which CSI is transmitted, the user terminal multiplexes the uplink control information including CSI (for example, A-CSI) onto the uplink shared channel and transmits it (case 2).

For example, the user terminal transmits uplink control information including CSI (for example, A-CSI) on the uplink shared channel of the licensed CC (case 2-1)). Alternatively, the user terminal transmits the uplink control information including the CSI on the uplink shared channel of the unlicensed CC (case 2-2)). The transmission method of CSI and indication information in each case (for example, mapping method) will be described below.

<Case 1>

When CSI and indication information are transmitted using an uplink control channel of a predetermined cell (for example, a licensed carrier), the user terminal separately encodes (separate coding) and transmits uplink control information including CSI and indication information. As a result of this, even when the size of uplink control information changes depending on the number of CCs (or the number of CSI processes) reported by the user terminal, the radio base station can decode the uplink control information after first decoding the indication information (fixed size) and confirming the size of the uplink control information). There are cases where the uplink control information includes only P-CSI and the case where the uplink control information includes HARQ-ACKs and/or SRs in addition to P-CSI.

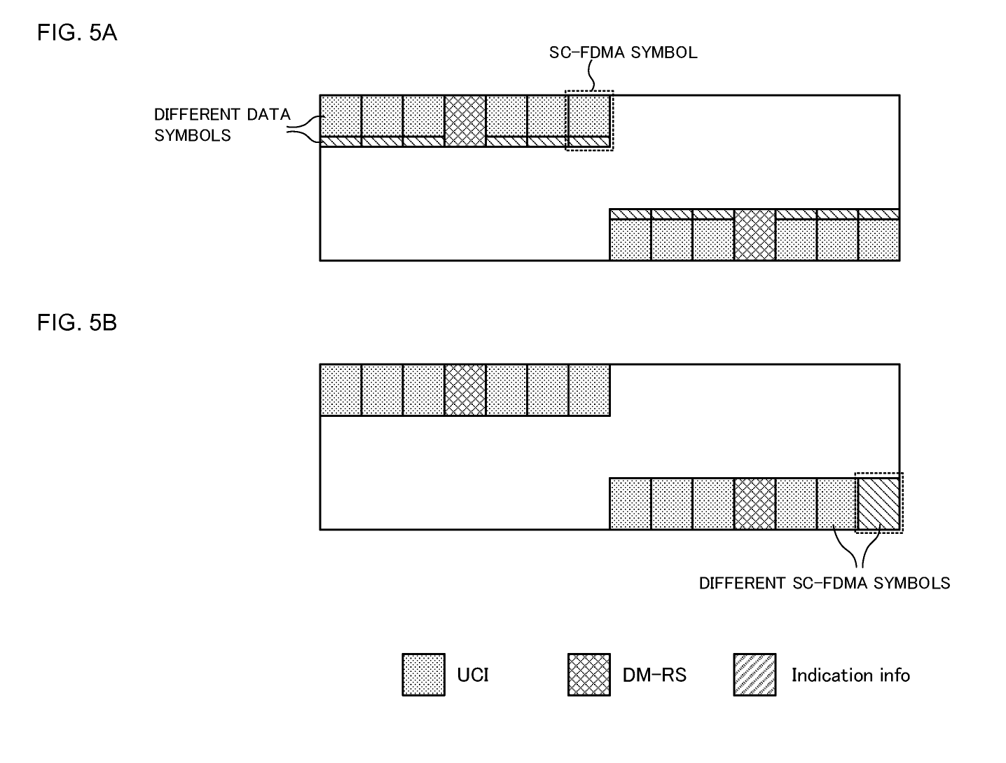

The user terminal can map the indication information and the uplink control information (CSI) to different data symbols in the same SC-FDMA symbol (see FIG. 5A). Alternatively, a configuration to map the indication information and the uplink control information to different SC-FDMA symbols may be adopted (see FIG. 5B).

Also, when uplink control information including P-CSI is transmitted in an uplink control channel, the user terminal applies a predetermined PUCCH format (PF) based on the size of the uplink control information.

In the present embodiment, since the number of CSIs (CSI having been successfully measured) reported from the user terminal varies depending on the result of DL listening or the like, the size of the uplink control information also changes.

However, in the present embodiment, it is possible to perform control so that the PUCCH format for transmitting uplink control information is not changed regardless of the number of CSIs reported from the user terminal (the number of CSIs having been successfully measured). That is, even when the number of valid CSI resources changes, the user terminal transmits uplink control information including P-CSI using the same PUCCH format.

For example, when P-CSI is configured, if the number of configured CSI reporting is greater than one, the user terminal applies the resource of a predetermined PUCCH format (for example, PF 4 and/or PF 5) that is reconfigured by high layer, regardless of the number of CSIs to be reported. Even when the size of uplink control information varies depending on the number of CSIs to be reported, it can be dealt with by applying a PF with large capacity. Further, the radio base station does not need to perform receiving control taking into consideration a plurality of PUCCH formats (for example, PF 2, PF 4/5, etc.). If there is only one CSI (CSI process) to be configured, the user terminal can transmit uplink control information including P-CSI by applying PF 2.

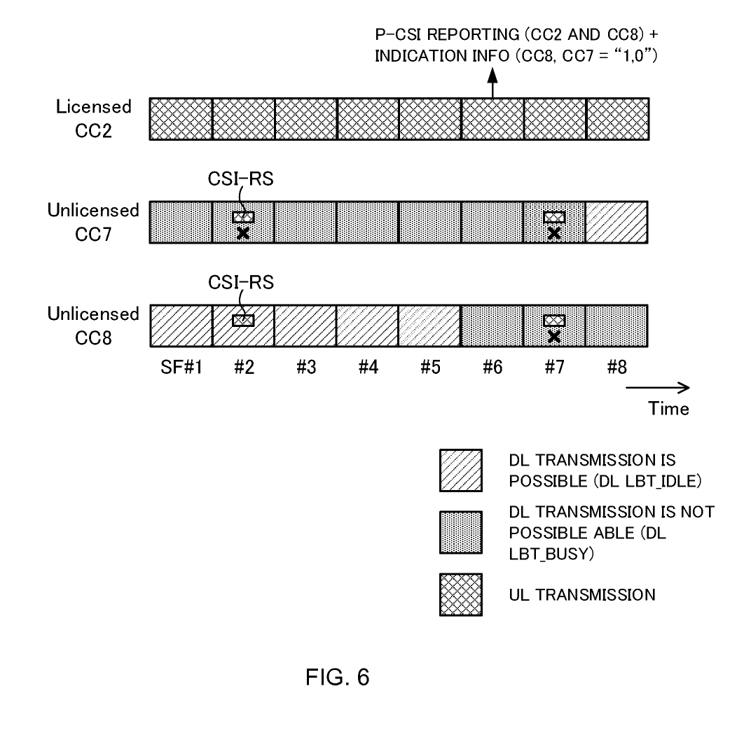

FIG. 6 shows an example of a P-CSI transmission method in a user terminal connected to one licensed CC 2 and two unlicensed CCs 7 and 8.

In the case shown here, CSI-RS transmission for the two unlicensed CCs 7 and 8 is configured in SF #2 and SF #7, and the CSI of each CC is reported in the uplink control channel of licensed CC 2.

In unlicensed CC 8, SF #2 indicates LBT_{idle}, and the CSI-RS is transmitted. Therefore, the user terminal can measure channel states by receiving the CSI-RS). On the other hand, in unlicensed CC 7, CSI-RS is not transmitted because SF #2 indicates LBT_{busy}. Therefore, in CSI reporting corresponding to SF #6, the user terminal performs control so that the CSI of unlicensed CC 7 is not reported.

In such a case, in CC #6, the user terminal transmits the CSI of licensed CC 2 and unlicensed CC 8 and indication information indicating that the CSI of unlicensed CC 8 is reported (indicating that the CSI of unlicensed CC 7 is not reported.

The user terminal can transmit indication information indicating the presence or absence of CSI reporting corresponding to unlicensed CC 7 and CC 8 using a 2-bit bitmap format). In this case, multiple CSIs (CSI processes) are configured to be reported in the user terminal, so that, regardless of the actual number of CSIs to be transmitted, the user terminal controls the transmission of uplink control information including P-CSI by using the resource of a preconfigured PUCCH format (for example, PF 4 and/or PF 5).

<Case 2-1>

When CSI (for example, A-CSI) and indication information are transmitted using the uplink shared channel of licensed CC (licensed carrier), the user terminal separately encodes (separate coding) and transmits uplink control information including CSI and indication information. As a result, even when the size of uplink control information varies depending on the number of CCs reported from the user terminal (or the number of CSI processes), the radio base station can decode the uplink control information after first decoding the indication information (fixed size) and confirming the size of the uplink control information). There are cases where the uplink control information includes only A-CSI and the case where uplink control information includes HARQ-ACK and/or SR in addition to A-CSI.

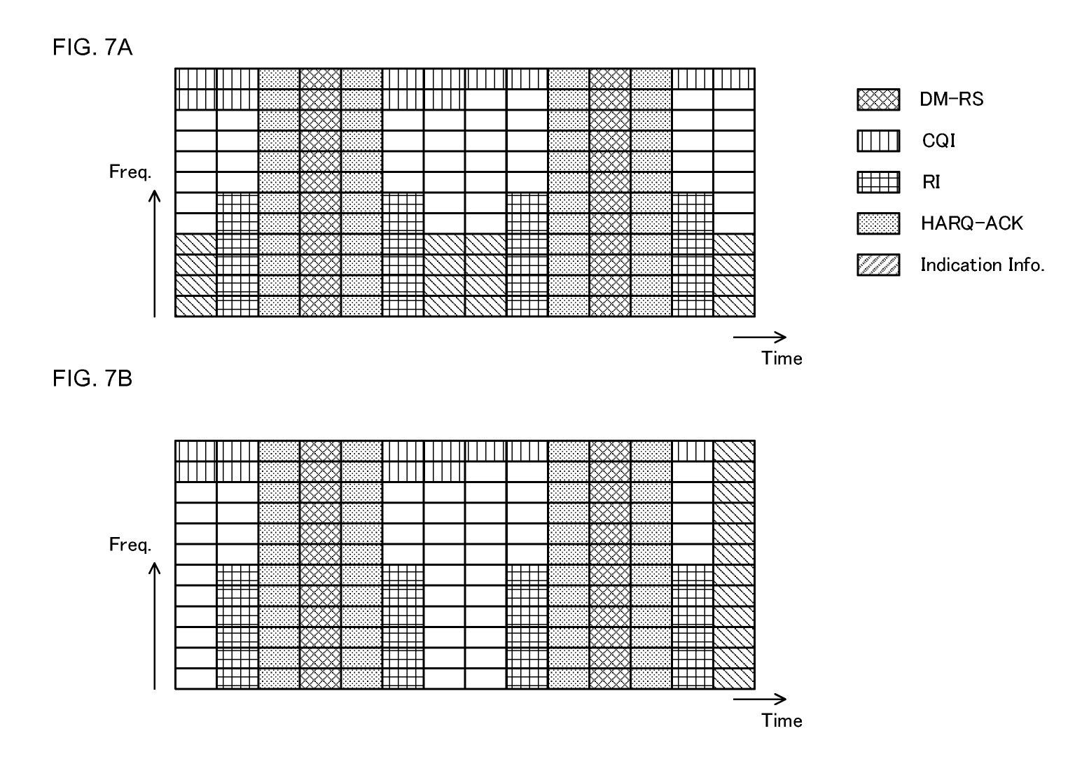

The user terminal can map indication information to neighboring parts of the resource (RE) to which the RI is mapped (for example, adjacent REs) (see FIG. 7A). Alternatively, the user terminal may map the indication information to the last valid SC-FDMA symbol in a UL subframe (see FIG. 7B).

<Case 2-2>

When CSI (for example, A-CSI) and indication information are transmitted using an uplink shared channel of an unlicensed CC (unlicensed carrier), the user terminal separately encodes (separate coding) and transmits uplink control information including the CSI, and indication information.

In this case, as in the case where an uplink shared channel of a licensed CC is used, the user terminal can map the indication information to a location close to the resource (RE) where the RI is mapped (for example, adjacent RE) (see FIG. 7A above.) Alternatively, the user terminal may map the indication information to the last valid SC-FDMA symbol in a UL subframe (see FIG. 7B above).

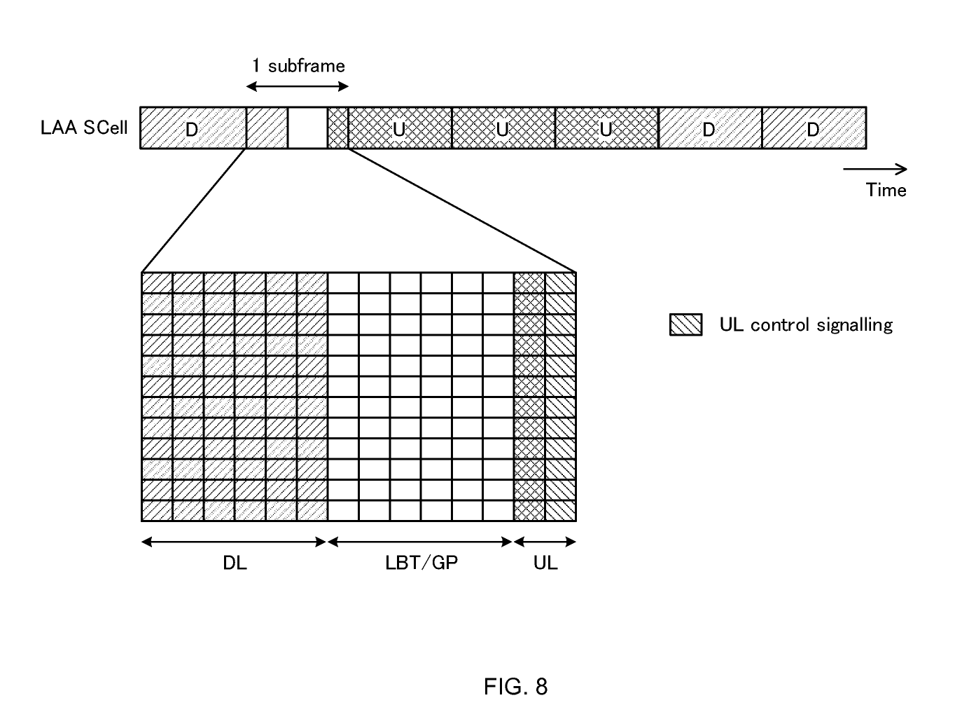

Alternatively, the user terminal can include and transmit indication information in an uplink control signal for an unlicensed CC to be transmitted at the time of starting UL transmission (see FIGS. 8). Further, the user terminal may be configured to map indication information (or an uplink control signal including indication information) to one of the last symbol in the subframe immediately before the UL subframe, the symbol in which UL transmission starts and the first symbol in the UL subframe.

### SECOND EXAMPLE

In the second example, a case will be explained where whether the user terminal transmits channel state information or not is controlled based on the measurement state of channel states of cells (the receiving state of the channel state measurement reference signal), and where, to cells where channel state information is not transmitted, other signals are transmitted.

At a predetermined timing at which CSI is reported, when there is a CC where measurement has been performed using a valid CSI resource (valid CSI resource has been received), the user terminal selectively transmits the measurement result (CSI) of this CC. On the other hand, the user terminal performs control so that CSI is not reported with respect to CCs that have not been measured (valid CSI resource has not been received) using valid CSI resources at a predetermined timing. In this case, the user terminal may transmit the indication information as shown in the first example.

Also, at a given timing, if there is a CC for which CSI is not reported, the user terminal will transmit another signal instead of the CSI of that CC. As this different signal, the user terminal can transmit a signal for enabling scheduling by the radio base station corresponding to a cell (for example, an unlicensed CC) for which CSI reporting is not possible.

Based on another signal transmitted from the user terminal, the radio base station can determine the cell (cell where CSI has not been reported) for which CSI has been reported from the user terminal. In this case, the user terminal may be configured not to transmit the indication information shown in the first example. Alternatively, the radio base station may identify the cell corresponding to the received CSI based on the indication information transmitted from the user terminal, as shown in the first example.

For example, instead of CSI reporting corresponding to a predetermined CC, the user terminal can report a channel quality measurement reference signal (for example, the SRS), information related to received power (for example, the RSSI measurement result), and the like). In addition to RSSI measurement results, RSRP, RSRQ, etc. may be reported as information related to received power.

To be more specific, in an unlicensed CC, if it is not possible to receive measurable CSI-RS resources due to LBT_{busy}, instead of reporting CSI at a given timing, the user terminal transmits the SRS and/or RSSI measurement result for the unlicensed CC.

When sending the SRS, the user terminal can send the SRS by applying a specific SRS configuration. A specific SRS configuration can be configured from the radio base station to the user terminal, such as via higher layer signaling (for example, RRC signaling and broadcast information). For example, the radio base station reports information about SRS parameters (antenna port, combs, frequency location, cyclic shift index, bandwidth, etc.) to the user terminal. A particular SRS configuration may be an existing SRS configuration, or a new configuration may be configured.

Thus, instead of CSI reporting corresponding to a predetermined cell, the user terminal transmits an SRS, to which a specific SRS configuration is applied, and the radio base station can control scheduling based on this SRS. Also, when different configurations are applied to the SRS normally transmitted by the user terminal and the SRS to be transmitted instead of CSI reporting, the radio base station side can judge the type of the SRS (whether the SRS is an SRS that has been sent instead of CSI reporting).

Similarly, if the user terminal reports RSSI, the user terminal may apply a specific RSSI configuration and report the RSSI. The specific RSSI configuration can be configured from the radio base station to the user terminal, such as via higher layer signaling (for example, RRC signaling and broadcast information)). For example, the radio base station reports information about the measurement duration (for example, one selected from 1, 24, 28, 42 and 70 OFDM symbols) of RSSI reporting to the user terminal.

Also, the user terminal reports the SRS and/or the RSSI in a subframe (subframe n+k) after a predetermined timing at which CSI is reported. For example, subframe n+k is a UL subframe which the user terminal can first use in an unlicensed CC. In this case, n is the subframe for which CSI is reported and k is an integer greater than or equal to 0 (k≥0).

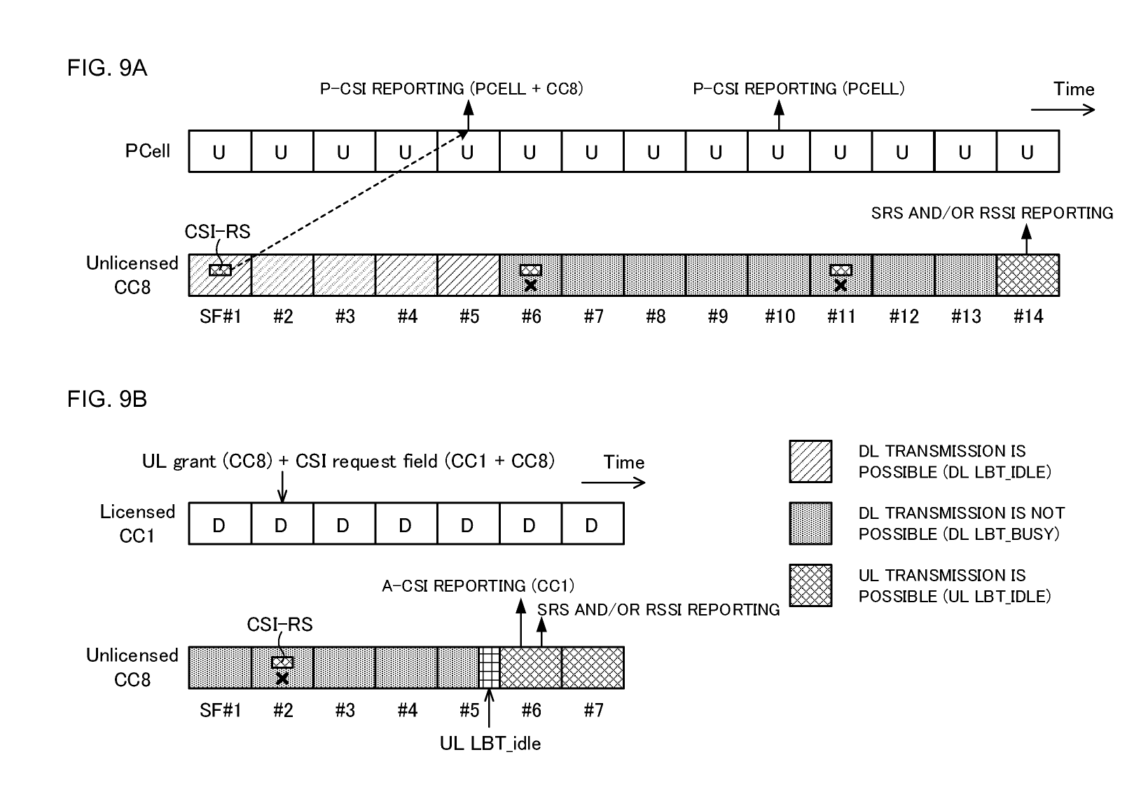

In addition, the user terminal transmits the SRS in the cell for which CSI was not reported. Also, the RSSI of a cell for which CSI was not reported can be reported in either cell (for example, an unlicensed CC, a licensed CC, etc.). Below, the case where SRS and/or RSSI are reported instead of CSI reporting will be explained with reference to FIG. 9.

In the example shown in FIG. 9, when CSI cannot be transmitted at a predetermined timing, the user terminal reports SRS and/or RSSI. FIG. 9A shows an example where the user terminal does not transmit P-CSI, and FIG. 9B shows an example where the user terminal does not transmit A-CSI.

In FIG. 9A, a case is assumed in which the user terminal connects to a licensed CC (PCell) and an unlicensed CC (CC 8) and reports P-CSI using the PCell's uplink control channel. In unlicensed CC 8, the CSI-RS transmission periodicity is configured to 5 ms, and the P-CSI reporting period (valid period) is also configured to 5 ms.

In SF #1 indicating LBT_{idle}, the user terminal can receive the CSI-RS (CSI resource) transmitted in unlicensed CC 8). Therefore, at a predetermined timing (SF #5), the user terminal transmits the CSI of unlicensed CC 8 using the PCell's uplink control channel.

On the other hand, in SF #6 indicating LBT_{busy}, the CSI-RS (CSI resource) is not transmitted in unlicensed CC 8, so that the user terminal cannot receive or measure the CSI-RS. Therefore, at a predetermined timing (SF #10) the user terminal reports the CSI of the PCell, but does not report the CSI of that unlicensed CC 8. In this case, the user terminal reports the SRS and/or the RSSI, instead of CSI reporting corresponding to unlicensed CC 8.

The user terminal reports SRS and/or RSSI in a subframe (SF #10+k (k≥0) after a predetermined timing at which CSI is reported (here, SF #10)). Here, the UL subframe that can be used first in unlicensed CC 8 is SF #15. Therefore, the user terminal can transmit the SRS in SF #15 (k=5), and/or the user terminal can report the RSSI in unlicensed CC 8. When RSSI is reported in the licensed CC, a subframe earlier than SF #15 may be used.

In FIG. 9B, a case is assumed in which the user terminal is connected to licensed CC 1 and unlicensed CC (CC 8), and A-CSI is reported using the unlicensed CC's uplink shared channel. In addition, a case is shown here where a UL grant corresponding to unlicensed CC 8 (including CSI trigger) is sent in licensed CC 1 (cross carrier scheduling).

The user terminal performs control so that, in in SF #2, downlink control information transmitted through licensed CC 1 is received, and, at a predetermined timing (here, SF #6), UL transmission and CSI reporting are performed via licensed CC 8. On the other hand, in SF #2, the CSI-RS is not transmitted in unlicensed CC 8 due to LBT_{busy}, so that the user terminal cannot receive and measure the CSI-RS.

Therefore, at a predetermined timing (SF #6), the user terminal reports the CSI of licensed CC 1, but does not report the CSI of that unlicensed CC 8). In this case, the user terminal is controlled to report the SRS and/or RSSI instead of CSI reporting of unlicensed CC 8.

In a subframe (SF #6+k (k≥0)) after a predetermined timing (here, SF #6) at which CSI is reported, the user terminal sends the SRS and/or report the RSSI. Here, the UL subframe that can be used first in unlicensed CC 8 is SF #6). Therefore, the user terminal can transmit the SRS in SF #6 (k=0), and/or the user terminal can report the RSSI in unlicensed CC 8. Note that the user terminal may report the RSSI in licensed CC 1.

Thus, instead of CSI reporting corresponding to a predetermined cell, the user terminal transmits an SRS to which a specific SRS configuration is applied, and, as a result of this, the radio base station can control scheduling based on this SRS.

(Radio Communication System)

Now, the structure of the radio communication system according to an embodiment of the present invention will be described below. In this radio communication system, the radio communication methods of the above-described embodiments are employed. Note that the radio communication methods of the above-described embodiments may be applied individually or may be applied in combination.

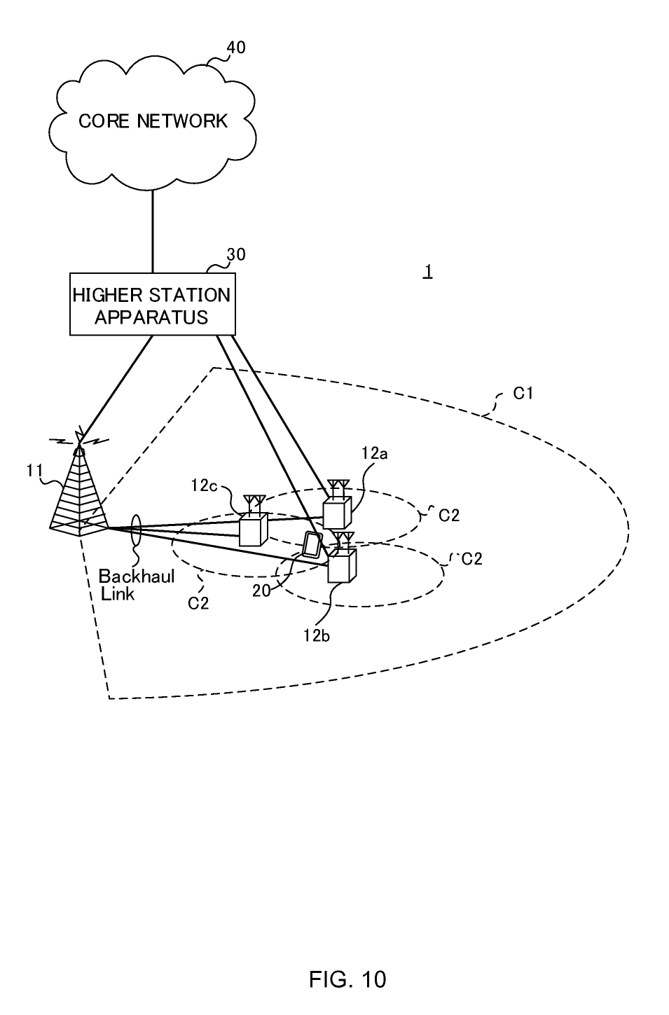

FIG. 10 is a diagram to show an example of a schematic structure of a radio communication system according to an embodiment of the present invention. The radio communication system 1 can adopt carrier aggregation (CA) and/or dual connectivity (DC) to group a plurality of fundamental frequency blocks (component carriers) into one, where the LTE system bandwidth (for example, 20 MHz) constitutes one unit. Note that the radio communication system 1 may be referred to as “SUPER 3G,” “LTE-A” (LTE-Advanced), “IMT-Advanced,” “4G,” “5G,” “FRA” (Future Radio Access) and so on.

The radio communication system 1 shown in FIG. 10 includes a radio base station 11 that forms a macro cell C1, and radio base stations 12a to 12c that form small cells C2, which are placed within the macro cell C1 and which are narrower than the macro cell C1. Also, user terminals 20 are placed in the macro cell C1 and in each small cell C2. Also, at least one of the cells can be configured to execute listening in the DL. A configuration in which different numerologies are applied between cells may be adopted. Note that “numerology” refers to a set of communication parameters that characterize the design of signals in a certain RAT and the design of RAT.

The user terminals 20 can connect with both the radio base station 11 and the radio base stations 12. The user terminals 20 may use the macro cell C1 and the small cells C2, which use different frequencies, at the same time, by means of CA or DC. Also, the user terminals 20 can execute CA or DC by using a plurality of cells (CCs) (for example, six or more CCs). Further, the user terminal can use license band CCs and unlicensed band CCs as a plurality of cells.

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the configuration of the frequency band for use in each radio base station is by no means limited to these.

A structure may be employed here in which wire connection (for example, means in compliance with the CPRI (Common Public Radio Interface) such as optical fiber, the X2 interface and so on) or wireless connection is established between the radio base station 11 and the radio base station 12 (or between two radio base stations 12).

The radio base station 11 and the radio base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with higher station apparatus 30 via the radio base station 11.

Note that the radio base station 11 is a radio base station having a relatively wide coverage, and may be referred to as a “macro base station,” a “central node,” an “eNB” (eNodeB), a “transmitting/receiving point” and so on. Also, the radio base stations 12 are radio base stations having local coverages, and may be referred to as “small base stations,” “micro base stations,” “pico base stations,” “femto base stations,” “HeNBs” (Home eNodeBs), “RRHs” (Remote Radio Heads), “transmitting/receiving points” and so on. Hereinafter the radio base stations 11 and 12 will be collectively referred to as “radio base stations 10,” unless specified otherwise.

The user terminals 20 are terminals to support various communication schemes such as LTE, LTE-A and so on, and may be either mobile communication terminals or stationary communication terminals.

In the radio communication system 1, as radio access schemes, OFDMA (orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are not limited to these combinations, and OFDMA may be used in the uplink.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data, higher layer control information and predetermined SIBs (System Information Blocks) are communicated in the PDSCH. Also, the MIB (Master Information Blocks) is communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI) including PDSCH and PUSCH scheduling information is communicated by the PDCCH. The number of OFDM symbols to use for the PDCCH is communicated by the PCFICH. HARQ delivery acknowledgement signals (ACKs/NACKs) in response to the PUSCH are communicated by the PHICH. The EPDCCH is frequency-division-multiplexed with the PDSCH (downlink shared data channel) and used to communicate DCI and so on, like the PDCCH.

In the radio communication system 1, an uplink shared channel (PUSCH: Physical Uplink Shared CHannel), which is used by each user terminal 20 on a shared basis, an uplink control channel (PUCCH: Physical Uplink Control CHannel), a random access channel (PRACH: Physical Random Access CHannel) and so on are used as uplink channels. User data and higher layer control information are communicated by the PUSCH. Uplink control information (UCI: Uplink Control Information), including at least one of delivery acknowledgment information (ACK/NACK) and radio quality information (CQI), is transmitted by the PUSCH or the PUCCH. By means of the PRACH, random access preambles for establishing connections with cells are communicated.

<Radio Base Station>

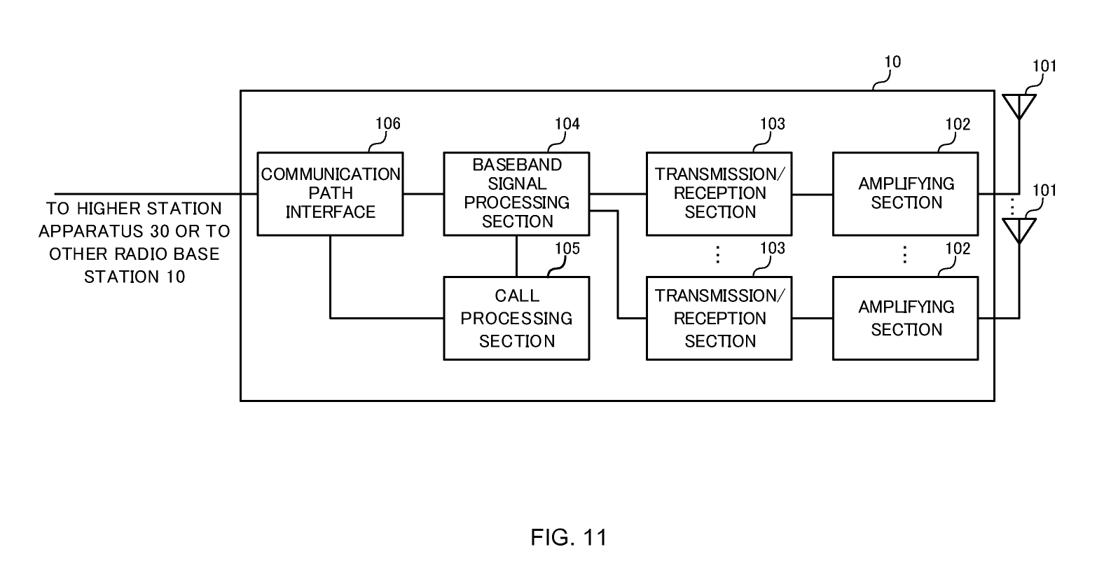

FIG. 11 is a diagram to show an example of an overall structure of a radio base station according to one embodiment of the present invention. A radio base station 10 has a plurality of transmitting/receiving antennas 101, amplifying sections 102, transmitting/receiving sections 103, a baseband signal processing section 104, a call processing section 105 and a communication path interface 106. Note that the transmitting/receiving sections 103 are comprised of transmitting sections and receiving sections.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving sections 103. Furthermore, downlink control signals are also subjected to transmission processes such as channel coding and an inverse fast Fourier transform, and forwarded to each transmitting/receiving sections 103.

Baseband signals that are pre-coded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101.

The transmitting/receiving sections 103 execute listening at least before DL transmission and controls transmission/reception with the user terminal. For example, the transmitting/receiving sections (transmitting sections) 103 transmit a channel state measurement reference signal to the user terminal depending on the result of listening. Further, the transmitting/receiving sections (receiving sections) 103 receive channel state information, which is controlled to be reported or not to be reported depending on the state of channel state measurement in the user terminal. In this case, the transmitting/receiving sections (receiving sections) 103 can receive indication information including information on the cells (for example, an unlicensed CC) subject to CSI reporting by the user terminal.

The transmitting/receiving sections 103 can be constituted by transmitters/receivers, transmitting/receiving circuits or transmitting/receiving devices that can be described based on common understanding of the technical field to which the present invention pertains. Note that a transmitting/receiving sections 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface section 106 transmits and receives signals to and from the higher station apparatus 30 via a predetermined interface. Also, the communication path interface 106 may transmit and/or receive signals (backhaul signaling) with other radio base stations 10 via an inter-base station interface (for example, an interface in compliance with the CPRI (Common Public Radio Interface), such as optical fiber, the X2 interface, etc.).

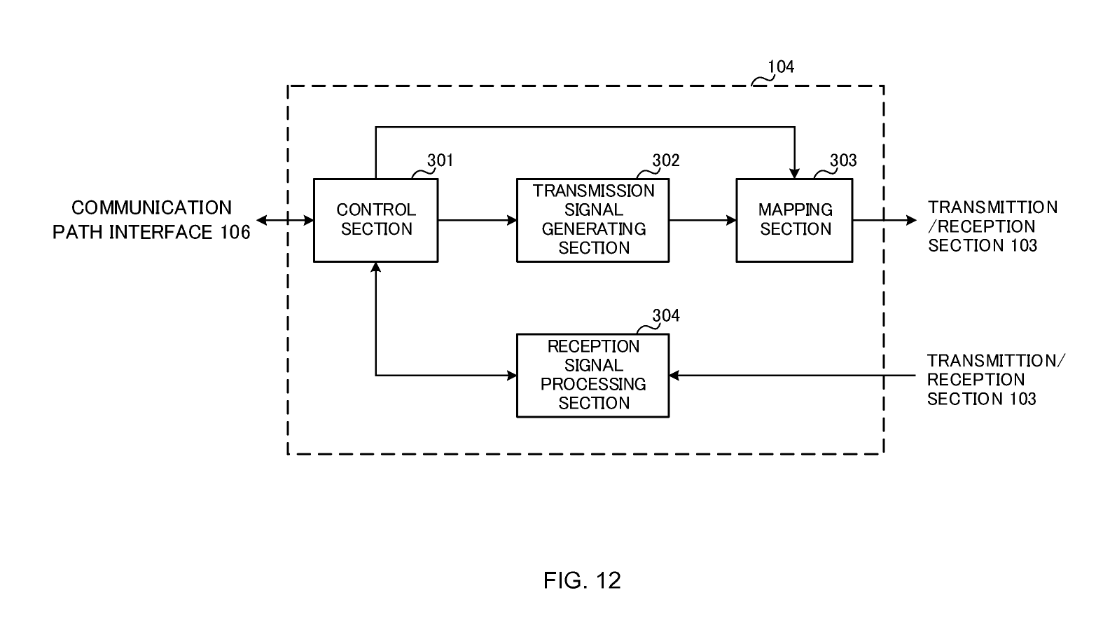

FIG. 12 is a diagram to show an example of a functional structure of a radio base station according to the present embodiment. Note that, although FIG. 12 primarily shows functional blocks that pertain to characteristic parts of the present embodiment, the radio base station 10 has other functional blocks that are necessary for radio communication as well. As shown in FIG. 12, the baseband signal processing section 104 has a control section (scheduler) 301, a transmission signal generation section (generation section) 302, a mapping section 303, a received signal processing section 304 and a measurement section 305.

The control section 301, for example, controls the generation of signals in the transmission signal generation section 302, the allocation of signals by the mapping section 303, and so on. Furthermore, the control section 301 controls the signal receiving processes in the received signal processing section 304, the measurements of signals in the measurement section 305, and so on.

The control section (scheduler) 301 controls the scheduling (for example, resource allocation) of downlink data signals that are transmitted in the PDSCH and downlink control signals that are communicated in the PDCCH and/or the EPDCCH. Also, the control section 301 controls the scheduling of system information, synchronization signals, paging information, CRSs (Cell-specific Reference Signals), CSI-RSs (Channel State Information Reference Signals) and so on. Furthermore, the control section 301 also controls the scheduling of uplink reference signals, uplink data signals that are transmitted in the PUSCH, and uplink control signals that are transmitted in the PUCCH and/or the PUSCH.

The control section 301 can control the transmitting/receiving sections 103 based on the result of listening. For the control section 301, a controller, a control circuit or a control device that can be described based on common understanding of the technical field to which the present invention pertains can be used.

The transmission signal generation section 302 generates DL signals (downlink control signals, downlink data signals, downlink reference signals and so on) based on commands from the control section 301, and outputs these signals to the mapping section 303. To be more specific, the transmission signal generation section 302 generates a downlink data signal (PDSCH) including user data, and outputs it to the mapping section 303. Further, the transmission signal generation section 302 generates a downlink control signal (PDCCH/EPDCCH) including DCI (UL grant), and outputs it to the mapping section 303. Further, the transmission signal generation section 302 generates downlink reference signals such as CRS and CSI-RS, and outputs them to the mapping section 303.

The mapping section 303 maps the downlink signals generated in the transmission signal generation section 302 to predetermined radio resources based on commands from the control section 301, and outputs these to the transmitting/receiving sections 103. For the mapping section 303, mapper, a mapping circuit or a mapping device that can be described based on common understanding of the technical field to which the present invention pertains can be used.

The received signal processing section 304 performs receiving processes (for example, demapping, demodulation, decoding and so on) of received signals that are input from the transmitting/receiving sections 103. Here, the received signals include, for example, uplink signals transmitted from the user terminals 20 (uplink control signals, uplink data signals, uplink reference signals and so on). For the received signal processing section 304, a signal processor, a signal processing circuit or a signal processing device that can be described based on common understanding of the technical field to which the present invention pertains can be used.

The received signal processing section 304 outputs the decoded information acquired through the receiving processes to the control section 301. For example, when a PUCCH to contain an HARQ-ACK is received, the received signal processing section 304 outputs this HARQ-ACK to the control section 301. Also, the received signal processing section 304 outputs the received signals, the signals after the receiving processes and so on, to the measurement section 305.

The measurement section 305 performs measurement related to received signals (for example, LBT). The measurement section 305 can be constituted by a measurer, a measurement circuit or a measurement device that can be described based on common understanding of the technical field to which the present invention pertains.

The measurement section 305 may measure the received power (for example, the RSRP (Reference Signal Received Power)), the received quality (for example, the RSRQ (Reference Signal Received Quality)), the SINR (Signal to Interference plus Noise Ratio), channel states, etc. of the received signals, for example. The measurement results may be output to the control section 301.

<User Terminal>

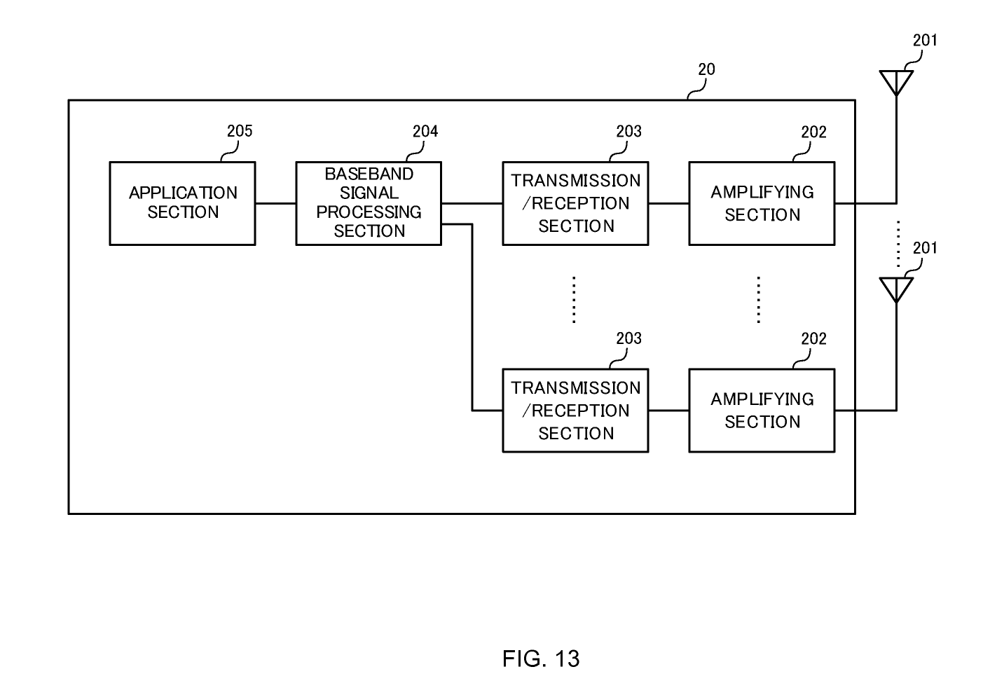

FIG. 13 is a diagram to show an example of an overall structure of a user terminal according to one embodiment of the present invention. A user terminal 20 has a plurality of transmitting/receiving antennas 201 for MIMO communication, amplifying sections 202, transmitting/receiving sections 203, a baseband signal processing section 204 and an application section 205. Note that the transmitting/receiving sections 203 may be comprised of transmitting sections and receiving sections.

Radio frequency signals that are received in a plurality of transmitting/receiving antennas 201 are each amplified in the amplifying sections 202. Each transmitting/receiving section 203 receives the downlink signals amplified in the amplifying sections 202. The received signal is subjected to frequency conversion and converted into the baseband signal in the transmitting/receiving sections 203, and output to the baseband signal processing section 204.

The transmitting/receiving sections (receiving sections) 203 receive DL signals (for example, downlink control information, downlink data) transmitted from the radio base station. Further, the transmitting/receiving sections (receiving sections) 203 receive the channel state measurement reference signal. For the transmitting/receiving sections 203, transmitters/receivers, transmitting/receiving circuits or transmitting/receiving devices that can be described based on common understanding of the technical field to which the present invention pertains can be used.

In the baseband signal processing section 204, the baseband signal that is input is subjected to an FFT process, error correction decoding, a retransmission control receiving process, and so on. Downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to each transmitting/receiving section 203. The baseband signal that is output from the baseband signal processing section 204 is converted into a radio frequency bandwidth in the transmitting/receiving sections 203. The radio frequency signals that are subjected to frequency conversion in the transmitting/receiving sections 203 are amplified in the amplifying sections 202, and transmitted from the transmitting/receiving antennas 201.

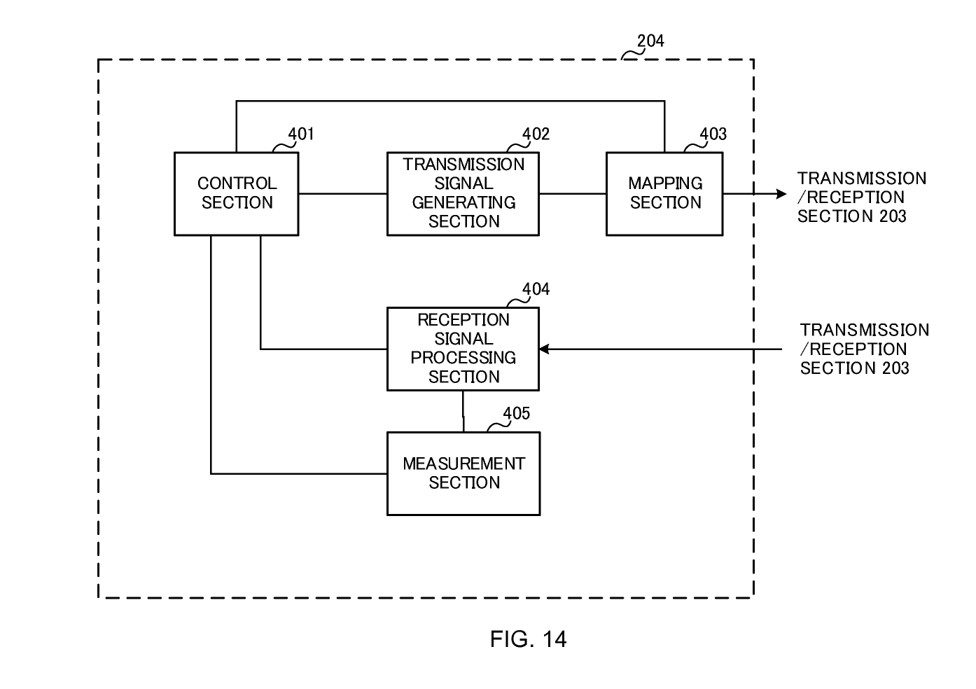

FIG. 14 is a diagram to show an example of a functional structure of a user terminal according to the present embodiment. Note that, although FIG. 14 primarily shows functional blocks that pertain to characteristic parts of the present embodiment, the user terminal 20 has other functional blocks that are necessary for radio communication as well. As shown in FIG. 14, the baseband signal processing section 204 provided in the user terminal 20 at least has a control section 401, a transmission signal generation section 402, a mapping section 403, a received signal processing section 404 and a measurement section 405.

The control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not re transmission control is necessary for the downlink data signals, and so on. To be more specific, the control section 401 can control the transmission signal generation section 402, the mapping section 403, the received signal processing section 404 and the measurement section 405.

The control section 401 performs control so that channel state information is transmitted at a predetermined timing, and also performs control so that whether or not to transmit channel state information of a cell where listening is employed based on the state of channel state measurement (see FIGS. 4). Also, when channel state information is transmitted, the control section 401 performs control so that indication information that indicates the cells (or the CSI processes) where channel state information is transmitted is also transmitted. The cells included in the indication information can be cells where listening is employed.

When uplink control information including channel state information and indication information is transmitted, the control section 401 can perform control so that the uplink control information and the indication information are encoded separately and transmitted (see FIGS. 5, FIGS. 7 and FIG. 8). For example, when uplink control information and indication information are transmitted using an uplink control channel of a cell where listening is employed, the control section 401 performs control so that the uplink control information and the indication information separately are mapped to different data symbols or different SC-FDMA symbols in the same SC-FDMA symbol (see FIGS. 5).

Alternatively, when uplink control information and indication information are transmitted using an uplink shared channel of a cell where listening is not employed, the control section 401 performs control so that the indication information is mapped to the starting symbol of a UL subframe and/or the last symbol of the immediately-preceding subframe of the UL subframe.

Also, when the channel state information of a cell where listening is employed is not transmitted at a predetermined timing, the control section 401 can perform control so that a channel quality measurement reference signal and/or information related to received power for the cell where listening is employed are transmitted (see FIGS. 9). For example, the control section 401 performs control so that the channel quality measurement reference signal and/or the information related to received power is transmitted in the UL subframe after the predetermined timing. The control section 401 can acquire the measurement result of the received power (for example, RSSI, etc.) from the measurement section 405.

For the control section 401, a controller, a control circuit or a control device that can be described based on common understanding of the technical field to which the present invention pertains can be used.

The transmission signal generation section 402 generates UL signals based on commands from the control section 401, and outputs these signals to the mapping section 403. For example, the transmission signal generation section 402 generates uplink control signals such as delivery acknowledgement signals (HARQ-ACKs), channel state information (CSI) and so on, based on commands from the control section 401.

Also, the transmission signal generation section 402 generates uplink data signals based on commands from the control section 401. For example, when a UL grant is included in a downlink control signal that is reported from the radio base station 10, the control section 401 commands the transmission signal generation section 402 to generate an uplink data signal. For the transmission signal generation section 402, a signal generator, a signal generating circuit or a signal generating device that can be described based on common understanding of the technical field to which the present invention pertains can be used.

The mapping section 403 maps the uplink signals (uplink control signals and/or uplink data) generated in the transmission signal generation section 402 to radio resources based on commands from the control section 401, and output the result to the transmitting/receiving sections 203. For the mapping section 403, mapper, a mapping circuit or a mapping device that can be described based on common understanding of the technical field to which the present invention pertains can be used.

The received signal processing section 404 performs receiving processes (for example, demapping, demodulation, decoding and so on) of received signals that are input from the transmitting/receiving section 203. Here, the received signals include, for example, downlink signals (downlink control signals, downlink data signals, downlink reference signals and so on) that are transmitted from the radio base station 10. The received signal processing section 404 can be constituted by a signal processor, a signal processing circuit or a signal processing device that can be described based on common understanding of the technical field to which the present invention pertains. Also, the received signal processing section 404 can constitute the receiving section according to the present invention.

The received signal processing section 404 blind-decodes DCI (DCI format) for scheduling transmission and/or reception of data (TB: Transport Block) based on commands from the control section 401.

The received signal processing section 404 output the decoded information that is acquired through the receiving processes to the control section 401. The received signal processing section 404 outputs, for example, broadcast information, system information, RRC signaling, DCI and so on, to the control section 401. Also, the received signal processing section 404 outputs the received signals, the signals after the receiving processes and so on to the measurement section 405.

The measurement section 405 conducts measurements with respect to the received signals. For example, the measurement section 405 measures channel states using the channel state measurement reference signal. The measurement section 405 can be constituted by a measurer, a measurement circuit or a measurement device that can be described based on common understanding of the technical field to which the present invention pertains.

The measurement section 405 may measure, for example, the received power (for example, RSRP), the received quality (for example, RSRQ, received SINR), the channel states and so on of the received signals. The measurement results may be output to the control section 401.

(Hardware Structure)

Note that the block diagrams that have been used to describe the above embodiments show blocks in functional units. These functional blocks (components) may be implemented in arbitrary combinations of hardware and/or software. Also, the means for implementing each functional block is not particularly limited. That is, each functional block may be implemented with one physically-integrated device, or may be implemented by connecting two physically-separate devices via radio or wire and by using these multiple devices.

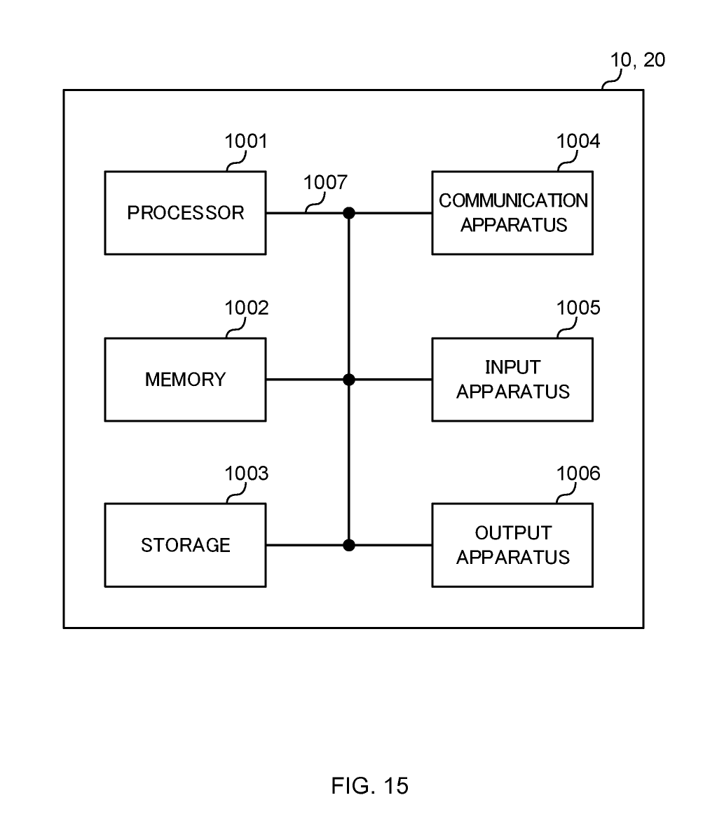

That is, the radio base stations, user terminals and so according to embodiments of the present invention may function as a computer that executes the processes of the radio communication method of the present invention. FIG. 15 is a diagram to show an example hardware structure of a radio base station and a user terminal according to an embodiment of the present invention. Physically, a radio base station 10 and a user terminal 20, which have been described above, may be formed as a computer apparatus that includes a processor 1001, a memory 1002, a storage 1003, a communication apparatus 1004, an input apparatus 1005, an output apparatus 1006 and a bus 1007.

Note that, in the following description, the word “apparatus” may be replaced by “circuit,” “device,” “unit” and so on. Note that the hardware structure of the radio base station 10 and the user terminal 20 may be designed to include one or more of each apparatus shown in the drawings, or may be designed not to include part of the apparatuses.

Each function of the radio base station 10 and the user terminal 20 is implemented by reading predetermined software (programs) on hardware such as the processor 1001 and the memory 1002, and by controlling the calculations in the processor 1001, the communication in the communication apparatus 1004, and the reading and/or writing of data in the memory 1002 and the storage 1003.

The processor 1001 may control the whole computer by, for example, running an operating system. The processor 1001 may be configured with a central processing unit (CPU) including an interface with a peripheral device, a control device, a computing device, a register, and the like. For example, the above-described baseband signal process section 104 (204), call processing section 105 and so on may be implemented by the central processing apparatus 1001.

Further, the processor 1001 reads a program (program code), a software module or data from the storage 1003 and/or the communication device 1004 to the memory 1002, and executes various processes according to these. As for the programs, programs to allow the computer to execute at least part of the operations of the above-described embodiments may be used. For example, the control section 401 of the user terminals 20 may be stored in the memory 1002 and implemented by a control program that operates on the processor 1001, and other functional blocks may be implemented likewise.

The memory 1002 is a computer-readable recording medium, and may be constituted by, for example, at least one of a ROM (Read Only Memory), an EPROM (Erasable Programmable ROM), a RAM (Random Access Memory) and so on. The memory 1002 may be referred to as a “register,” a “cache,” a “main memory” (primary storage apparatus) or the like. The memory 1002 can store executable programs (program codes), software modules, and the like for implementing the radio communication methods according to embodiments of the present invention.

The storage 1003 is a computer readable recording medium, and is configured with at least one of an optical disk such as a CD-ROM (Compact Disc ROM), a hard disk drive, a flexible disk, a magneto-optical disk, a flash memory and so on. The storage 1003 may be referred to as a “secondary storage apparatus.”

The communication apparatus 1004 is hardware (transmitting/receiving device) for allowing inter-computer communication by using wired and/or wireless networks, and may be referred to as, for example, a “network device,” a “network controller,” a “network card,” a “communication module” and so on. For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, etc.). The output apparatus 1006 is an output device for allowing sending output to the outside (for example, a display, a speaker, etc.). Note that the input apparatus 1005 and the output apparatus 1006 may be provided in an integrated structure (for example, a touch panel).

Further, the respective devices such as the processor 1001 and the memory 1002 are connected by a bus 1007 for communicating information. The bus 1007 may be formed with a single bus, or may be formed with buses that vary between the apparatuses.

For example, the radio base station 10 and the user terminal 20 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 1001 may be implemented with at least one of these hardware.

Note that the terminology used in this description and the terminology that is needed to understand this description may be replaced by other terms that convey the same or similar meanings. For example, “channels” and/or “symbols” may be replaced by “signals” (or “signaling”). Also, “signals” may be “messages.” Furthermore, “component carriers” (CCs) may be referred to as “cells,” “frequency carriers,” “carrier frequencies” and so on.

Further, a radio frame may be comprised of one or more periods (frames) in the time domain. Each of one or more periods (frames) constituting a radio frame may be referred to as a “subframe.” Further, a subframe may be comprised of one or more slots in the time domain. Further, a slot may be comprised of one or more symbols (OFDM symbols, SC-FDMA symbols, etc.) in the time domain.

A radio frame, a subframe, a slot and a symbol all represent the time unit in signal communication. Radio frames, subframes, slots and symbols may be called by other names. For example, one subframe may be referred to as a “transmission time interval” (TTI), or a plurality of consecutive subframes may be referred to as a “TTI,” and one slot may be referred to as a “TTI.” That is, a subframe and a TTI may be a subframe (one ms) in existing LTE, may be a shorter period than one ms (for example, 1 to 13 symbols), or may be a longer period of time than one ms.

Here, a TTI refers to the minimum time unit of scheduling in wireless communication, for example. For example, in LTE systems, the radio base station schedules the allocation radio resources (such as the frequency bandwidth and transmission power that can be used by each user terminal) to each user terminal in TTI units. The definition of TTIs is not limited to this.

A resource block (RB) is a resource allocation unit in the time domain and the frequency domain, and may include one or a plurality of consecutive subcarriers in the frequency domain. Also, an RB may include one or more symbols in the time domain and may be one slot, one subframe or one TTI in length. One TTI and one subframe each may be comprised of one or more resource blocks. Note that an RB may be referred to as a “physical resource block” (PRB: Physical RB), a “PRB pair,” an “RB pair,” or the like.

Further, a resource block may be comprised of one or more resource elements (REs). For example, one RE may be a radio resource field of one subcarrier and one symbol.

Note that the structures of radio frames, subframes, slots, symbols and the like described above are merely examples. For example, configurations such as the number of subframes included in a radio frame, the number of slots included in a subframe, the number of symbols and RBs included in a slot, the number of subcarriers included in an RB, the number of symbols in a TTI, the symbol duration and the cyclic prefix (CP) length can be variously changed.

Also, the information and parameters described in this description may be represented in absolute values or in relative values with respect to a predetermined value, or may be represented in other information formats. For example, radio resources may be specified by predetermined indices.

The information, signals and/or others described in this description may be represented by using a variety of different technologies. For example, data, instructions, commands, information, signals, bits, symbols and chips, all of which may be referenced throughout the description, may be represented by voltages, currents, electromagnetic waves, magnetic fields or particles, optical fields or photons, or any combination of these.

Also, software and commands may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation and microwaves), these wired technologies and/or wireless technologies are also included in the definition of communication media.

Further, the radio base station in this specification may be read by a user terminal. For example, each aspect/embodiment of the present invention may be applied to a configuration in which communication between a radio base station and a user terminal is replaced with communication of a plurality of user terminals (D2D: Device-to-Device). In this case, the user terminal 20 may have the functions of the radio base station 10 described above. In addition, wording such as “uplink” and “downlink” may be interpreted as “side.” For example, an uplink channel may be interpreted as a side channel.

Likewise, a user terminal in this specification may be interpreted as a radio base station. In this case, the radio base station 10 may have the functions of the user terminal 20 described above.

The examples/embodiments illustrated in this description may be used individually or in combinations, and the mode of may be switched depending on the implementation. Also, a report of predetermined information (for example, a report to the effect that “X holds”) does not necessarily have to be sent explicitly, and can be sent implicitly (by, for example, not reporting this piece of information).

Reporting of information is by no means limited to the example s/embodiments described in this description, and other methods may be used as well. For example, reporting of information may be implemented by using physical layer signaling (for example, DCI (Downlink Control Information) and UCI (Uplink Control Information)), higher layer signaling (for example, RRC (Radio Resource Control) signaling, broadcast information (the MIB (Master Information Blocks) and SIBs (System Information Blocks) and so on) and MAC (Medium Access Control) signaling, other signals or combinations of these. Also, RRC signaling may be referred to as “RRC messages,” and can be, for example, an RRC connection setup message, RRC connection reconfiguration message, and so on. Also, the MAC signaling may be reported, for example, by a MAC control element (MAC CE (Control Element)).

The examples/embodiments illustrated in this description may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other adequate systems, and/or next-generation systems that are enhanced based on these.

The order of processes, sequences, flowcharts and so on that have been used to describe the examples/embodiments herein may be re-ordered as long as inconsistencies do not arise. For example, although various methods have been illustrated in this description with various components of steps in exemplary orders, the specific orders that illustrated herein are by no means limiting.

Now, although the present invention has been described in detail above, it should be obvious to a person skilled in the art that the present invention is by no means limited to the embodiments described herein. For example, the above-described embodiments may be used individually or in combinations. The present invention can be implemented with various corrections and in various modifications, without departing from the spirit and scope of the present invention defined by the recitations of claims. Consequently, the description herein is provided only for the purpose of explaining example s, and should by no means be construed to limit the present invention in any way.

The disclosure of Japanese Patent Application No. 2016-020218, filed on Feb. 4, 2016, including the specification, drawings and abstract, is incorporated herein by reference in its entirety.

1. A user terminal that communicates by using a cell in which listening is applied at least prior to DL transmission, the user terminal comprising:
a measurement section that measures a channel state using a channel state measurement reference signal; and
a control section that controls transmission of channel state information at a predetermined timing,
wherein the control section controls whether to transmit the channel state information based on a measurement state of the channel state, and controls transmission of indication information that indicates a cell where the channel state information is transmitted.

2. The user terminal according to claim 1, wherein the control section performs control so that, when the channel state information is transmitted, the channel state information and the indication information are transmitted at the same time.

3. The user terminal according to claim 1, wherein the cell included in the indication information is a cell in which listening is applied.

4. The user terminal according to claim 2, wherein, when uplink control information including the channel state information and the indication information are transmitted, the control section performs control so that the uplink control information and the indication information are encoded separately and transmitted.

5. The user terminal according to claim 4, wherein, when the uplink control information and the indication information are transmitted using an uplink control channel of the cell where listening is applied, the control section performs control so that the uplink control information and the indication information are separately mapped to different data symbols or different SC-FDMA symbols in the same SC-FDMA symbol.

6. The user terminal according to claim 4, wherein, when the uplink control information and the indication information are transmitted using an uplink shared channel of a cell where listening is not applied, the control section performs control so that the indication information is mapped to a starting symbol of a UL subframe and/or a last symbol in an immediately-preceding subframe of the UL subframe.

7. The user terminal according to claim 1, wherein, when channel state information of the cell where listening is applied is not transmitted at the predetermined timing, the control section performs control so that the channel quality measurement reference signal and/or information related to received power for the cell where listening is applied are transmitted.

8. The user terminal according to claim 7, wherein the control section transmits the channel quality measurement reference signal and/or the information related to received power in a UL subframe after the predetermined timing.

9. A radio base station that communicates with a user terminal by applying listening at least prior to DL transmission, the radio base station comprising:
a transmission section that transmits a channel state measurement reference signal to the user terminal according to a result of listening; and
a receiving section that receives channel state information, which is controlled to be or not to be reported based on a measurement state of the channel state in the user terminal, and indication information that indicates a cell where the user terminal transmits the channel state information.

10. A radio communication method for a user terminal that communicates using a cell in which listening is applied at least prior to DL transmission, the radio communication method comprising the steps of:
measuring a channel state using a channel state measurement reference signal; and
controlling transmission of channel state information at a predetermined timing,
wherein whether to transmit the channel state information is controlled based on a measurement state of the channel state, and also transmission of indication information that indicates a cell where the channel state information is transmitted is controlled.

11. The user terminal according to claim 2, wherein the cell included in the indication information is a cell in which listening is applied.

12. The user terminal according to claim 3, wherein, when uplink control information including the channel state information and the indication information are transmitted, the control section performs control so that the uplink control information and the indication information are encoded separately and transmitted.
